(19) United States
(12) Patent Application Publication
(10) Pub. No.: US 2024/0349737 A1
(43) Pub. Date: Oct. 24, 2024

(54) PIE BAKING ASSIST APPARATUS

(71) Applicants: Chen Hollander, Ben Shemen (IL); Dor Shaim, Haifa (IL)

(72) Inventors: Chen Hollander, Ben Shemen (IL); Dor Shaim, Haifa (IL)

(21) Appl. No.: 18/136,361

(22) Filed: Apr. 19, 2023

(51) Int. Cl. A21B 3/13

(52) U.S. Cl. CPC A21B 3/13

(57) ABSTRACT

Baking assist apparatus has a passive resistance band formed of a continuous, thin-walled, flexible, elongate web element formed of a heat resistant material. An outward-facing surface of the web element is configured for positioning against an inward-facing surface of a wall of an unbaked pie crust so as to impart thereto a manually applied compressive force causing compression of the pie crust wall against a pie pan rigid peripheral wall such that the pie crust wall adopts the shape thereof and so as to adopt a selected thickness; and one or both edges of the web element are configured for impressing into a surface of the unbaked pie crust juxtaposed to the pie crust wall so as to assist in anchoring the web element and fixating the pie crust dough wall so as resist deformation during baking.

### FIELD OF THE INVENTION

The present invention relates to baking generally, and to the baking of pie crusts. in particular.

### BACKGROUND OF THE INVENTION

The blind baking of pies in pie pans, is well known. A typical pie pan or dish has a circular flat base and an outwardly angled sidewall extending therefrom at angle equal to or greater than 90 degrees, terminating in a rim or lip. Pie dishes, which may be made of metal, glass or other suitable material, may alternatively have other, non-circular shapes. Conventional pie pans are also formed with a non-stick coating, which while in itself desirable, enables the pie shell to pull away from the pan surface during baking. This is described further, below.

In the process of blind baking, the crust is partially baked before the contents of the pie are added, after which the pie will be baked further until fully baked. As a first step of preparation of a pie shell or crust, Initially, rolled pastry of a desired thickness is draped over the entire pan and then molded into the interior shape thereof, lying flat on the base and having an edge wall whose contours follows those of the inward-facing surface of the sidewall. Excess pastry extending beyond the rim may be trimmed, thereby to receive a pie crust shape or shell that substantially follows the interior contours of the dish. Typically, the pie pan will be selected for an aesthetically pleasing form that it is desired to impart to the pic.

During the baking of the shell, the dough tends to expand and become somewhat deformed or puffed up in relation to its original shape and can become detached from the anti-stick or non-stick coated surface of the pan. The sidewall expands laterally and the base expands or puffs up vertically. In particular, in the presence of the rigid wall of the pie pan, the sidewall expands laterally inward. Furthermore, the flat floor portion of the pastry shell expands upwardly due to the entrapment of air and moisture between the floor portion and the base of the pie pan. The expansion of the base can exacerbate the problem of deformation, as it effectively causes shrinkage of the pie shell towards the center, causing undesired distortion of the shell, once baked.

One approach towards the above problem is the use of approximately 1 kg ceramic baking weights. Baking weights of other materials and various shapes are also known.

In the art, various suggestions for improving the outcome of blind baking are known, including those disclosed in U.S. Pat. Nos. 1,699,239; 1,834,402; 2,026,829 2,411,857; 2,784,664; 2,993,614; 3,322,074; 4,228,731; 5,456,162; 7,517,933; 11,266,153; D15,489; D369,941; D384,550; D384,857; D610,865 and the following patent applications having publication numbers 2003/0183089; 2005/0211101; 2006/0027104 and 2008/0134906.

### SUMMARY OF THE INVENTION

The present invention seeks to provide a pie baking assist apparatus overcoming disadvantages of known art.

There is thus provided baking assist apparatus for use in the baking of an unbaked pie crust having a malleable dough base and a malleable peripheral dough wall extending transversely therefrom formed in and overlying a pie pan having a rigid base and a rigid peripheral wall extending transversely therefrom. The baking assist apparatus has a passive resistance band formed of a continuous, thin-walled, flexible, elongate web element formed of a heat resistant material having mutually parallel inward-facing and outward-facing surfaces separated by a predetermined web thickness, the surfaces terminating at first and second mutually parallel edges defining a web height therebetween. The dough wall has an outward-facing surface and an inward-facing surface, and the outward-facing surface of the web element is configured for positioning against the inward-facing surface of the dough wall of the pie crust, and the web element is configured to impart to the dough wall a manually applied compressive force causing compression thereof against the rigid peripheral wall of the pie pan such that the dough wall adopts the shape of the rigid peripheral wall and so as to adopt a selected thickness, and one or both of the edges of the web element are configured for impressing into a surface of the unbaked pie crust juxtaposed to the dough wall so as to assist in anchoring the web element in the compression position, thereby to fixate the pie crust dough wall portion and to resist deformation thereof during baking.

Additionally, the rigid peripheral wall of the pie pan has a predetermined closed, geometric shape, and wherein band is constructed so as to be deployable within and parallel to the rigid peripheral so as to be spaced therefrom by a predetermined uniform spacing S at all locations therealong.

Further, the band has a first, total length along its periphery and the rigid side wall of the pan has an interior face having a second, total length therealong, wherein the first total length is less than the second total length such that when the band is fully deployed within the pan, the band defines the spacing S from the rigid sidewall, the spacing equals a predetermined pie crust wall thickness.

Additionally, the rigid wall of the pan terminates in a peripheral rim at a predetermined height above the base of the pan, and the web has a height of magnitude that is no less than the difference between the predetermined height of the peripheral rim and the minimum desired thickness of the malleable dough base.

Further, the band has an inward-facing surface, and the baking assist apparatus also includes a band support element formed as a disc whose periphery is configured to fit within the band when fully deployed, and to assist the band in resisting inward deformation forces during baking.

Additionally, the band support element has a downward-facing surface and is configured to fit within the band so as to overlie the dough base, thereby to resist its tendency to puff up during baking.

Further, the band support element is formed with a plurality of vents extending through the thickness thereof, configured to release gas pressures accumulating within the dough base during baking.

Additionally, the band and the support element formed of an elastically deformable polymer.

Further, the band and the support element are formed of food grade silicone.

Additionally, the band is formed of an elastically deformable polymer, and wherein the baking assist apparatus also includes a band expander for insertion within the band when deployed, and for applying an outward pressure therealong.

Further, the band expander includes an adjustable rigid ring for placement within and parallel to the band; and a plurality of force transmission elements disposed along the periphery of the adjustable ring, each the force transmission element being radially mounted onto the periphery of the ring and having a force transmission head configured to engage the inward-facing surface of the web element so as to apply an outward force thereto.

Additionally, the first and second edges of the web element are of equal length.

Further, the rigid peripheral wall of the of pan slopes outwards, the edge of the web element configured for impressing into a surface of the unbaked pie crust is the first edge, and wherein the length of the first edge of the band is shorter than the length of the second edge of the band.

Additionally, the pie pan is a fluted pie pan whose rigid peripheral wall has a predetermined wavelike configuration, and wherein the outward-facing surface of the band is configured to have a similar configuration thereto, so as to be parallel thereto when positioned within the pan.

Further, the pie pan is a fluted pie pan whose rigid peripheral wall has a predetermined wavelike configuration, and wherein the outward-facing surface of the band and the periphery of the band support element are configured to have a similar configuration to that of the rigid peripheral wall, so as to be parallel thereto when positioned within the pan.

### BRIEF DESCRIPTION OF THE DRAWINGS

The present invention will be more fully understood and appreciated from the following detailed description taken in conjunction with the drawings in which:

FIG. 1A is an exploded view of a pie crust being prepared for baking in a plain pie pan, employing a baking assist apparatus in accordance with an embodiment of the present invention;

FIG. 1B is a cross-sectional view of the pie crust and baking assist apparatus of FIG. 1A in position in the pie pan;

FIG. 1C is an enlarged cut away side view of the pie crust and baking assist apparatus of FIG. 1A in position in the pie pan;

FIG. 1D is an enlarged cut away side view of the pie crust and baking assist apparatus of FIG. 1A in position in the pie pan;

FIG. 2 is an exploded view of a pie crust being prepared for baking in a plain pie pan, employing a baking assist apparatus in accordance with an alternative embodiment of the present invention;

FIGS. 3A and 3B are plan and cross-sectional views of the baking assist apparatus seen in FIG. 2;

FIG. 4A is a cross-sectional view of the pie crust and assist apparatus of FIGS. 2-3B in position in the pie pan;

FIG. 4B is an enlarged cut away side view of the pie crust and assist apparatus of FIGS. 2-3B in position in the pie pan;

FIGS. 5A and 5B are plan and cross-sectional views of the assist apparatus seen in FIGS. 3A and 3B, configured for use with a pie pan having a perpendicular sidewall;

FIG. 5C is a cross-sectional view of a pie pan having a perpendicular sidewall for use with the assist apparatus of FIGS. 5A and 5B;

FIG. 6A is a schematic plan view of an adjustable band expander for expanding the resistance band depicted herein;

FIG. 6B is a schematic illustration of a size adjustment mechanism of the expander of FIG. 6A, as seen at detail 6B therein;

FIG. 7 is an enlarged cut away side view of the pie crust and assist apparatus, similar to that seen in FIG. 1C, but also showing a portion of the expander of FIG. 6A in use;

FIG. 8 is an exploded view of a fluted pie pan and baking assist apparatus in accordance with an additional embodiment;

FIGS. 9A and 9B are sectional and elevational views, respectively, of a portion of an expander configured for use with the band of FIG. 8, in operative engagement therewith;

FIGS. 10-13 are perspective views of variously configured resistance bands, for use with correspondingly configured fluted baking pans, in accordance with further embodiments;

FIG. 14 is an interior elevation of a portion of the resistance band as shown and described above in conjunction with FIGS. 1A-5B, located in a pie crust during baking;

FIG. 15A is a cross-sectional view along line 15-15 of the band of FIG. 14 when configured as the conical band of FIGS. 1A-4B, illustrating a typical mechanical force regime during baking;

FIG. 15B is a cross-sectional view along line 15-15 of the band of FIG. 14 when configured as the cylindrical band of FIGS. 5A and 5B, illustrating a typical mechanical force regime during baking;

FIGS. 16A and 16B are interior isometric and elevational views of a portion of the reinforced resistance band as shown and described above in conjunction with FIGS. 8-9B, located in a pie crust during baking; and

FIG. 17 is a cross-sectional view of the band of FIGS. 16A and 16B, along line 17-17 of FIG. 16B, illustrating a typical mechanical force regime during baking.

### DETAILED DESCRIPTION

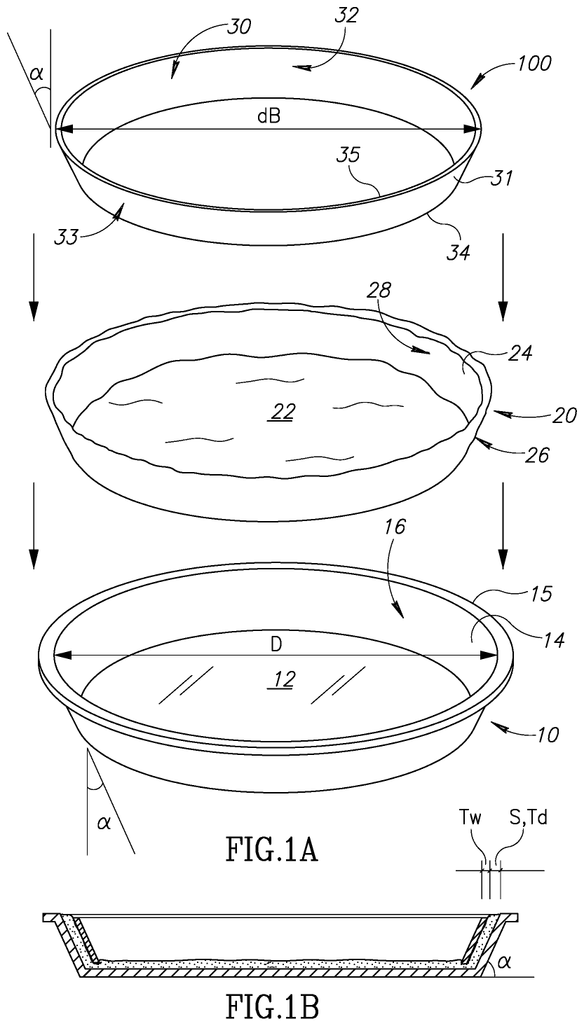

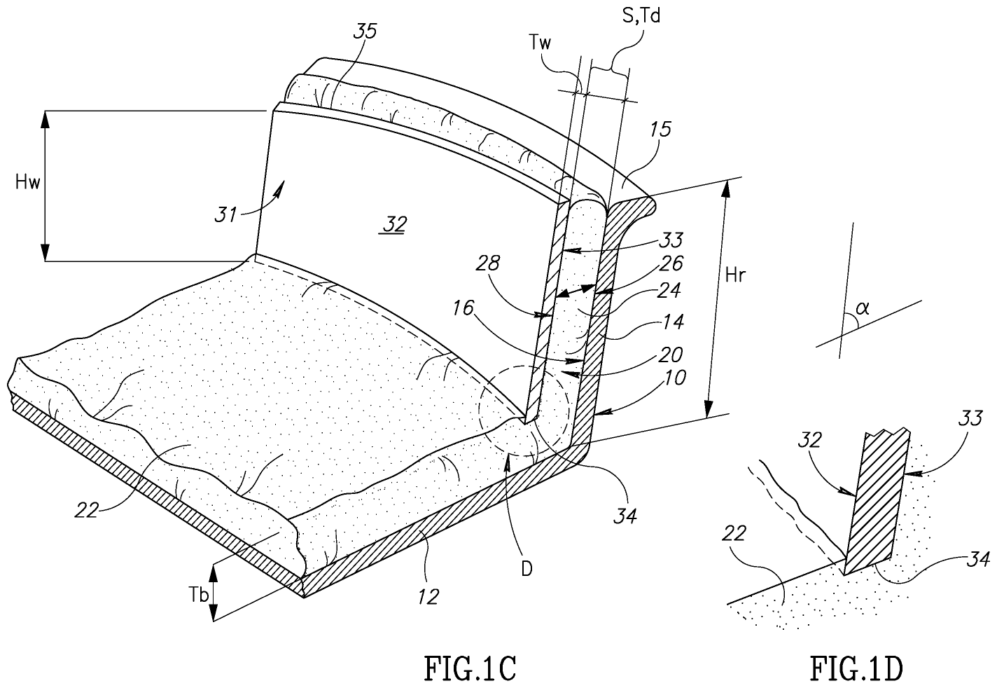

Reference is now made to FIGS. 1A-1C in which is depicted a pie pan 10 containing an unbaked pie crust or shell 20, having therein baking assist apparatus 100 of which a passive resistance band 30 therein is depicted, in accordance with an embodiment of the invention.

Pan 10 is of generally conventional structure, being formed of metal and having a rigid base 12, a rigid peripheral wall 14 extending transversely therefrom, which terminates in a rim 15. It will be appreciated that pan 10 may alternatively be configured as a glass baking dish.

In the illustrated embodiment, wall 14 slopes outwards, being generally conical.

Unbaked pie crust 20 is formed of malleable, unbaked dough, and is formed as known in the art within pan 10 so as to overlie it and is typically manually molded to fit into the pan 10 so as to have a similar shape thereto. As seen, crust 20 has a malleable dough base 22 and a malleable peripheral dough wall 24 extending transversely therefrom, along and supported by peripheral wall 14 of pan 10. As seen in FIG. 1A, dough wall 24 has an outward-facing surface 26 which is formed against an inward-facing surface 16 of peripheral wall 14 of pan 10, and an inward-facing surface 28.

Band 30 is a continuous, thin-walled, flexible, clongate web element 31 having mutually parallel inward-facing and outward-facing surfaces, respectively referenced 32 and 33. As indicated in FIG. 1C, surfaces 32 and 33 are separated by a predetermined web thickness Tw, and terminate at first and second, lower and upper mutually parallel edges 34 and 35, respectively, defining therebetween a web height Hw. Preferably, band is formed of a food grade silicone, as well known in the art.

Preferably, band 30 is dimensioned so that when fully extended and placed within the unbaked crust 20, its outward-facing surface 33 overlies the inward-facing surface 28 of dough wall 24 in full-surface to surface touching, frictional engagement therewith, while outward-facing surface 26 of dough wall 24 is similarly maintained in full surface-to-surface touching engagement with inward-facing surface 16 of the pan peripheral wall 14. When positioning the band 30 as described, the fingers of a user are employed by manually applying a compressive force to the band 30 and thus also to dough wall 24, thereby to press both pairs into mutual touching engagement as described above. As seen particularly in FIGS. 1C and 1D, band 30 is also pushed downwards relative to pie crust 20 such that lower edge 34 of the band 30 is lightly impressed into a surface of the unbaked pie crust 20 juxtaposed to the dough wall 24, thereby anchoring band 30 and thus further resist expansive pressures applied by the dough wall 24 when baked.

The described anchoring of web element 31, the friction between the mutually touching surfaces of web element 31 and unbaked dough wall 24, and the structural integrity of the web element 31 together help to resist expansion of the hitherto unbaked dough wall 24 during baking such that it generally retains its shape and position, thereby to produce a baked crust of high aesthetic quality. Furthermore, as the baked crust does not substantially shrink, as happens without using band 30, the resulting pie shell has a volume that is substantially similar to the unbaked shell, therefore resulting in a pie whose size is larger than that obtained in the prior art.

As described above, band 30 has a conical shape which corresponds to the shape of peripheral wall 14 of pan 10. In accordance with the present embodiment,
(Lwu−Leu)=(Lwl−Lel) is proportional to S
wherein
Lwu is the circumferential length of inward-facing surface 16 of pan wall 14 where it meets rim 15;
Leu is the external circumferential length of upper edge 35;
Lwl is the circumferential length of inward-facing surface 16 of pan wall 14 where it meets base 12;
Lel is the external circumferential length of lower edge 34; and
S, as depicted in FIG. 1C, is a uniform spacing between the outward-facing surface 33 of band 30 and inward-facing surface 16 of pan wall 14. S also equals a desired thickness (Td) of the dough wall 24, in both an unbaked state and also after baking. This is also reflected in the similar angular inclinations a of the outward-facing surface 33 of band 30 and inward-facing surface 16 of pan wall 14, as depicted in FIG. 1A.

Furthermore, in order to ensure substantial overlap of dough wall 24 by band 30, the height (Hw) of its outward-facing surface 33 as measured between the top and bottom edges 35 and 34, respectively, is such that Hw=Hr−Tb·(Sin α)⁻¹, wherein Hr is the height of rim 15 above base 12 as measured along inward-facing surface 16 of pan 10, and Tb is the thickness of dough base 22.

Typical dimensions, by way of example only, are, for a conical pie pan 10 having a diameter D=23.5 cm, and wherein the desired dough thickness Td=3-5 mm, such that dB=D−2Td, in which dB is the diameter of band 30.

The thickness Tw of web 31 is predetermined on the one hand, so as to provide sufficient stability in the force loading conditions as generally described below in conjunction with FIGS. 15-17, while retaining sufficient flexibility so as to facilitate manipulation of the dough by a person's fingers through the web 31, so as to mold the dough into full engagement with the inward-facing surface 16 of pan 10. Typically, for a pan whose diameter is 23.5 cm and depth of 25-35 mm, a web thickness Tw of 2-3 mm is appropriate.

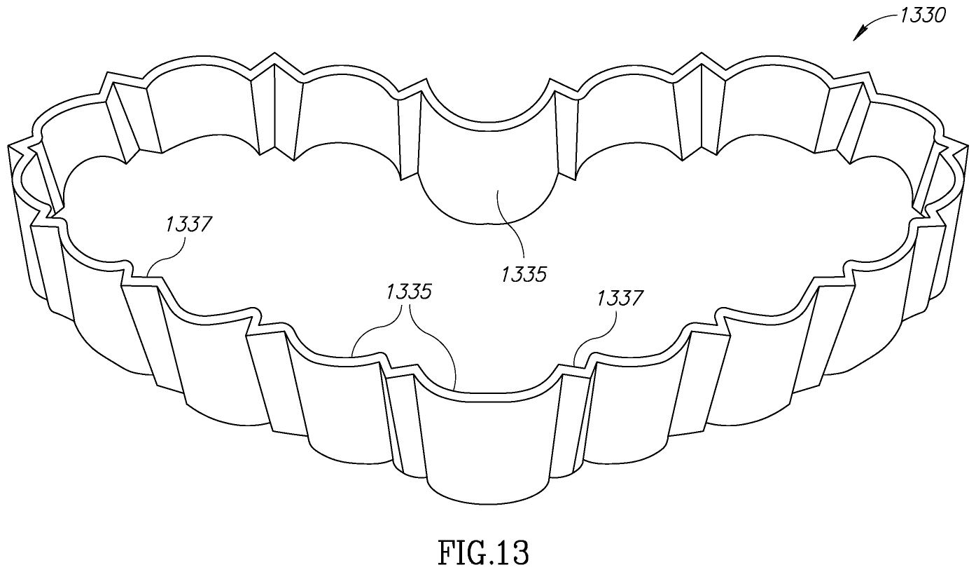

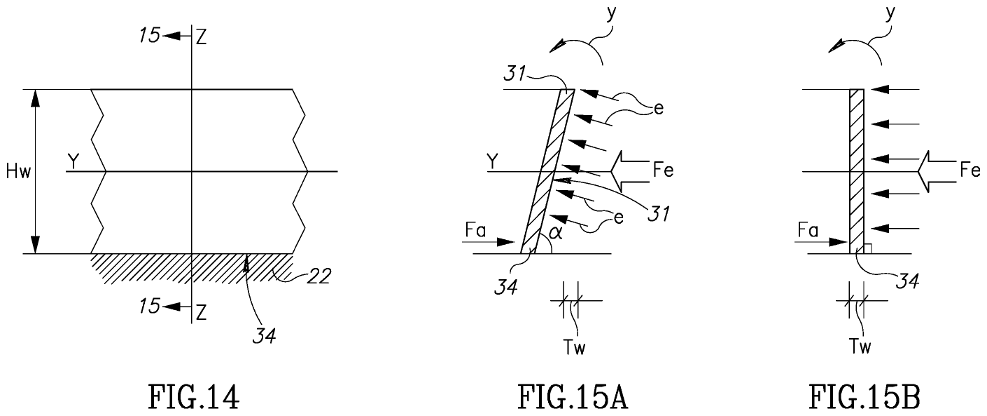

Reference is now made to FIG. 14, which is an interior elevation of a portion of the web 31 of resistance band 30 as shown and described above in conjunction with FIGS. 1A-5B, located in a pie crust during baking. As shown and described above, and as seen in the cross-sectional views of FIGS. 15A and 15B, band 30 in its entirety may be either conical (FIG. 15A) or cylindrical (FIG. 15B), and has, in the present example, an axis of symmetry Z. The band 30, which is a segment of a cone (FIG. 15A) or an annulus (FIG. 15B), also has an axis of bending Y.

As will be appreciated by persons skilled in the art, the ability of band 30 to be able to resist the expansion force Fe and thus to resist the expansion of the pie crust during baking is dependent on a number of components which include the following:

Anchoring Force (Fa): As described above and as depicted in FIGS. 15A and 15B, lower edge 34 of web 31 is positioned against or slightly indented into dough base 22, so as to form a frictional interface therewith, so as to be quasi-anchored in position; the anchoring force being denoted as Fa.

Stiffness/Resistance to Flexure: While web 31 is highly flexible, it nonetheless has a certain inherent structural stiffness, namely a resistance to bending or flexure in the direction of bending axis Y. The stiffness is a function, inter alia, of the web thickness Tw as a proportion of its height Hw, wherein the higher the value of (Tw/Hw), the stiffer the web 31.

It has been observed by the inventors that the use of band 30 during baking of the pie crust assists in the retention of the shape not only of the dough wall 24, but also, to a certain extent, of the base 22, reducing the extent to which the base puffs up during baking.

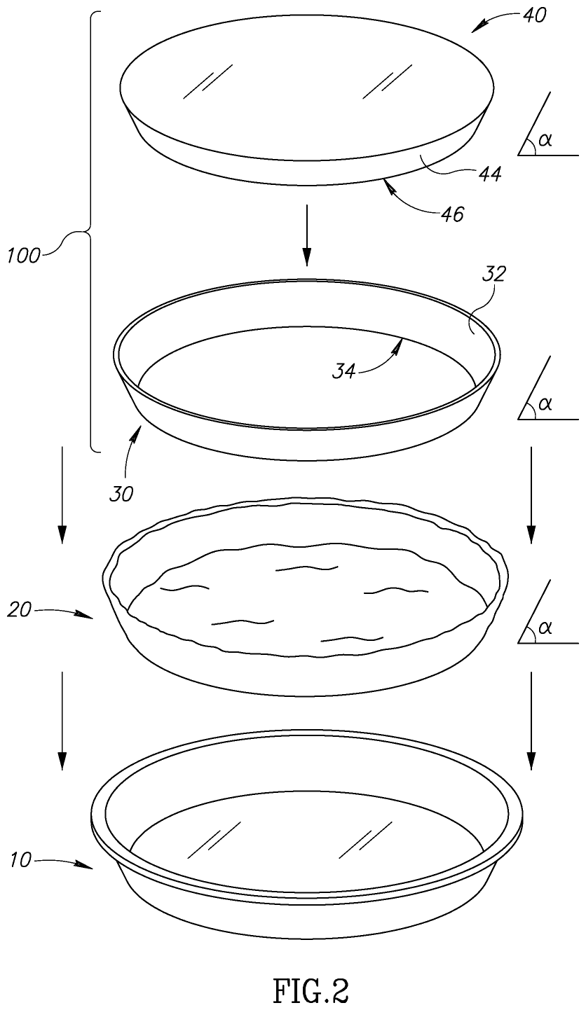

Referring now to FIGS. 2-4B, there is seen a pie pan 10 with unbaked pie crust 20 and band 30, substantially as shown and described above in conjunction with FIGS. 1A-1B, but wherein baking assist apparatus 100 also includes a band support element, referenced 40. Band support element 40, is formed as a disc of typically uniform thickness whose periphery is configured to fit within band 30 when fully deployed within crust 20 so as to reinforce the outward radial resistance applied by the band in response to a tendency by the pie wall to not only expand and deform during baking. but also to sag due to vertical expansion of the crust base 22.

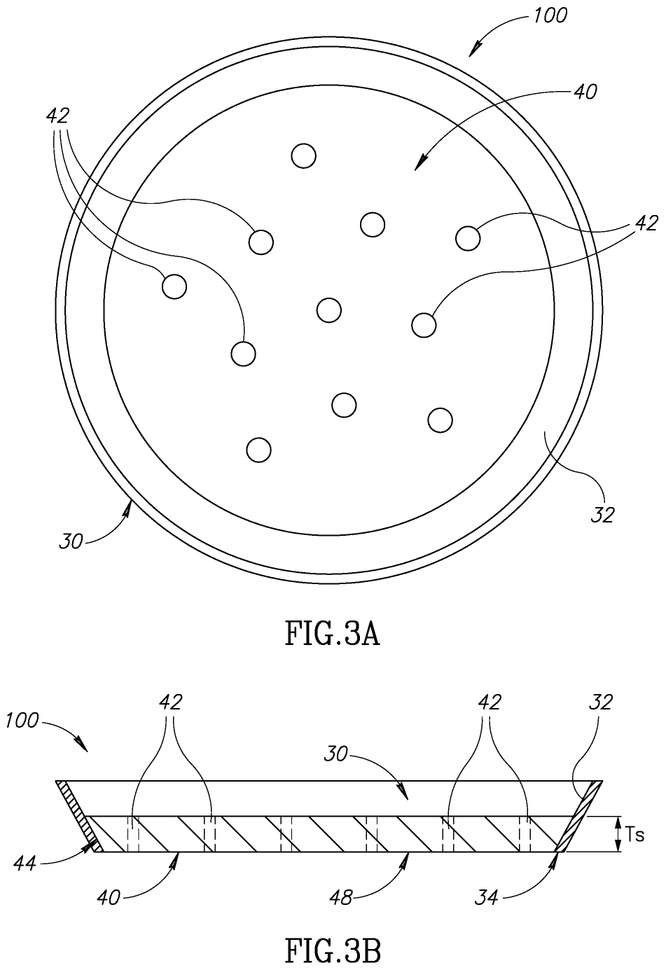

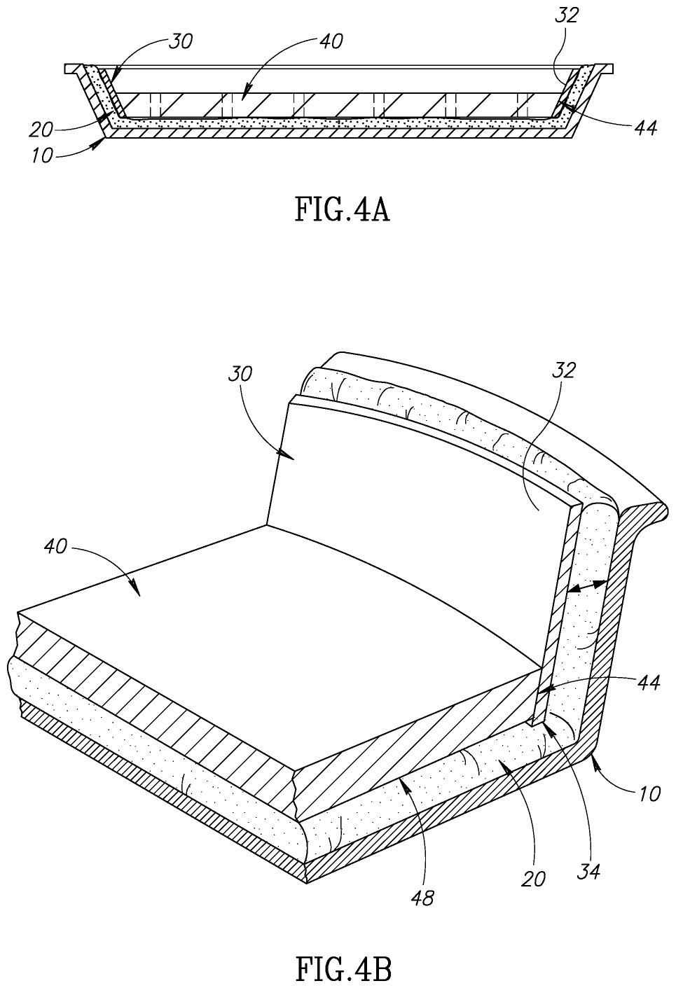

According to one embodiment, band support element 40 is made of a lightweight material, typically food grade silicone, and may typically have a thickness Ts (FIG. 3B) of approximately 5-10 mm. Accordingly, as opposed to the 1 kg weights used in the art to weigh down the pastry base so as to prevent it from expanding, support element 40 typically has a weight of no more than about 250-500 grams. As seen in FIGS. 4A and 4B, support element 40 (FIGS. 4A and 4B) completely overlies base 22, thereby resisting its tendency to puff up during baking. An advantage of the present support element is that its resistance to the puffing up of the base is not as a result of its mass, per se, but as a result of its shape and inherent stiffness. As seen, it is configured to be fully inserted within band 30 so as to fully overlay base 22 and so as to apply a substantially uniform force thereacross. Furthermore, once the pie begins to bake, the expansion of the pie wall which seeks to compress band 30 inwards, also has the effect of compressing the band 30 against the support element 40, further increasing its resistance to the expansion of base 22. This mutual anchoring of band 30 and element 40 serves also to supplement the anchoring force Fa (FIG. 15A) and the inherent resistance to rotation of web 31.

It will thus be appreciated that that baking assist apparatus 100 operates efficiently as an integrated unit, resisting expansion and deformation of the pie crust as whole, thereby facilitating maximum retention of the desired shape.

Optionally, as seen in FIGS. 3A and 3B, support element 40 may also be provided with a plurality of vents 42 for allowing moist air to escape and thus reducing pressure that would otherwise be applied by pie base 22 as it seeks to expand.

So as to fit precisely within band 30, the angular inclination of the outward-facing surface 44 of band support element 40 is equal to that of the inward-facing surface 32 of band 30, denoted in the drawings as a.

In the present embodiment, both band 30 and support element 40 are conical, so as to have lower and upper edges of different peripheral lengths or circumferences. In the illustrated embodiment, as seen in FIG. 2, the lower edge of support element 40 is designated 46 and the corresponding lower edge of inward-facing surface 32 of band 30 is designated 34. As seen in the drawings, particularly in FIGS. 3B-4B, these lower edges are substantially equal in length, such that lower face 48 of support element 40 is substantially coplanar with lower edge 34 of band 30 (FIGS. 3B and 4B). In this situation, it is envisaged that baking assist apparatus 100 is dimensioned for use with a selected baking pan 10 of dimensions so as to obtain full engagement of band 30 with peripheral dough wall 24, as described above in detail, in conjunction with FIGS. 1A-1D. In the case of a round pan 10, full engagement is obtained by using a band whose radius equals the radius of the pan minus a space S equal to the thickness of the peripheral dough wall Td, as shown and described above.

In accordance with an alternative embodiment, it is envisaged that it may be sought to employ a support element 40 whose lower edge 46 has a peripheral length or circumference that is greater than the corresponding dimension of lower edge 34 of band 30. Accordingly, while support element 40 can be axially inserted into band 30 until lower face 48 of support element 40 is substantially coplanar with lower edge 34 of band 30, this will require application of a force so as to cause an outward or radial expansion of band 30. This may be useful in a case in which it is sought to use band 30 in a pan 10 which would otherwise result in space S and dough wall thickness Td that is greater than desired, or if it is sought to obtain a thinner than usual pie wall thickness Td. For such situations, support element 40 may be formed with internal stiffening elements, rods or the like (not shown), so as to enable its forced insertion into band 30, as described.

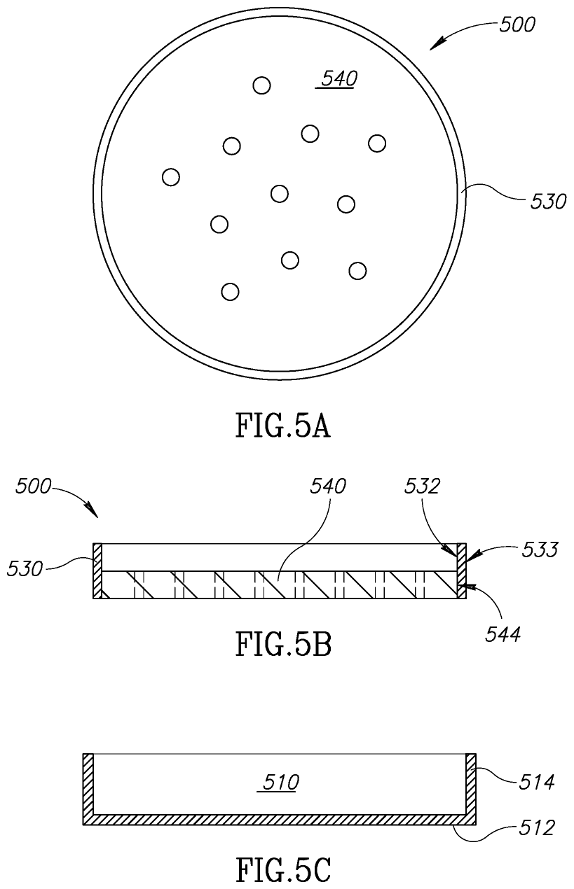

Referring now to FIGS. 5A-5C, there is shown a baking assist apparatus 500 which is generally similar to apparatus 100 shown and described hereinabove in conjunction with FIGS. 2A-4B, except as described herein. Accordingly, components and features of apparatus 500 that are similar to such components and features shown and described above in conjunction with apparatus 100, are depicted herein with the same reference numerals but having a prefix “5”, and are not otherwise described again 10 herein in detail, except as may be required so as to understand the present embodiment.

It will thus be appreciated that baking assist apparatus 500 is configured for use with a baking pan 510 whose sidewall 514 is perpendicular with respect to the base 512. Accordingly, both band 530 and support element 540 are cylindrical in shape, as are inward and outward-facing surfaces 532 and 533 of band 530, and outward-facing surface 544 of support element 540.

As described above, in conjunction with FIGS. 2-4B, it may be desirable to expand passive resistance band 30, whether to make the band fit better within the baking pan 10 (FIGS. 1A-4B), or to apply extra force to the dough wall 24 (FIGS. 1A-4B).

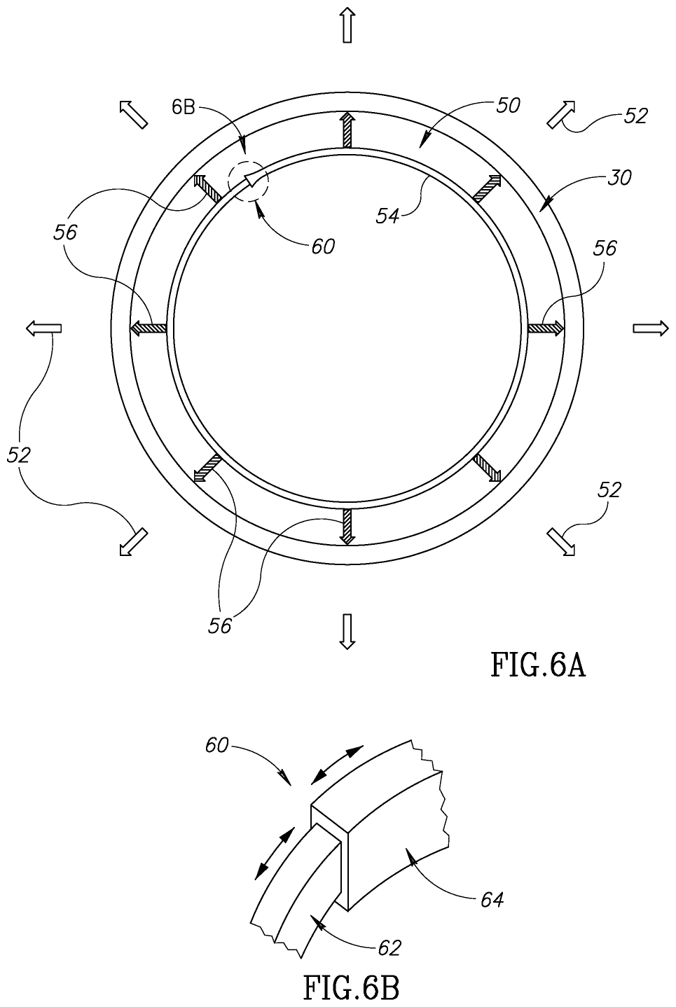

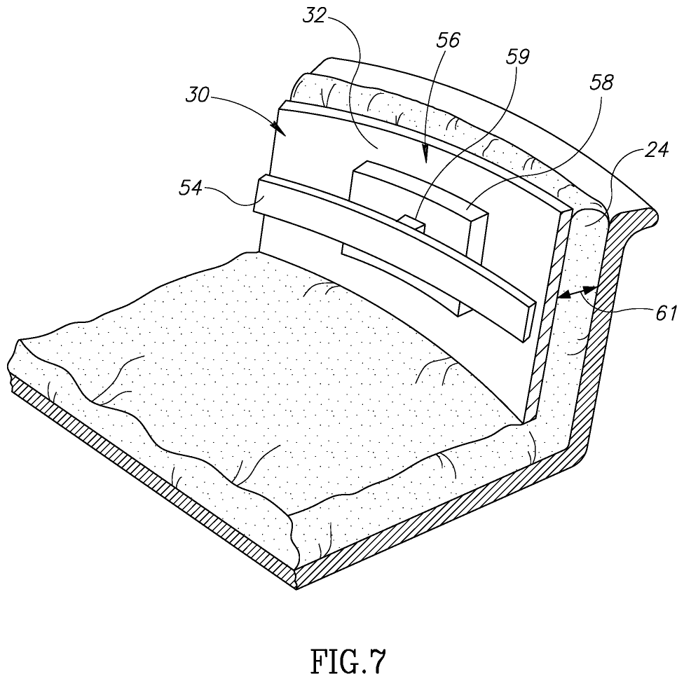

Accordingly, and with reference to FIGS. 6A-7, baking assist apparatus 100 may also include an adjustable band expander 50, shown schematically in FIG. 6A. Expander 50 is configured to fit inside resistance band 30 after deployment thereof, namely, after band 30 has been opened out to its full position within the dough shell 20, and to apply an outward pressure along the band, as depicted by arrows 52. The effect of the expansion is either to bring the outward-facing surface 33 of web element 31 into touching engagement with pie wall 24 or, as indicated by arrow 61 in FIG. 7, to apply an outward pressure to the pie wall 24 so as to limit or reduce its thickness.

As seen in FIG. 7, expander 50 typically includes an adjustable rigid ring 54 for placement within and parallel to band 30, and a plurality of force transmission elements 56 radially disposed along the periphery of adjustable ring 54. Typically, cach transmission element 56 has a force transmission head 58 mounted onto ring 54 via a connector 59. Heads 58 are operative to engage inward-facing surface 32 so as to apply an outward force thereto, as described. In one embodiment, each head 58 and connector 59 are formed as a single element made of a suitable heat resistant food grade polymer, although alternative configurations and alternative materials, such as stainless steel, may also be employed.

As mentioned, ring 54 is rigid and adjustable, and may be made from any suitable material such as stainless steel or a rigid, food grade polymer onto which transmission elements 56 can be mounted. Typical, non-limiting dimensions, of ring 54, by way of example, are 10 mm in height and 0.4 mm thick.

As seen schematically in FIG. 6B, there is provided an expansion mechanism 60, typically having tightly fitting mutually mating male and female ends, referenced respectively 62 and 64, achievable by any suitable high friction silicone coating, as known in the art. Alternatively, other types of selectably lockable mechanisms may be employed, such as a locking screw or other suitable fastener.

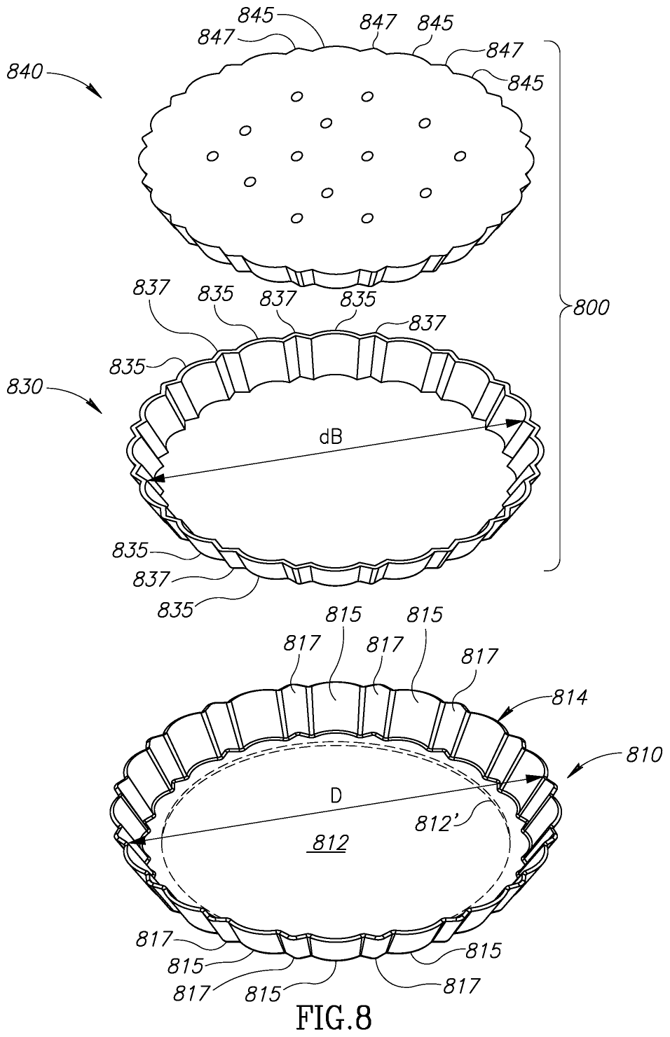

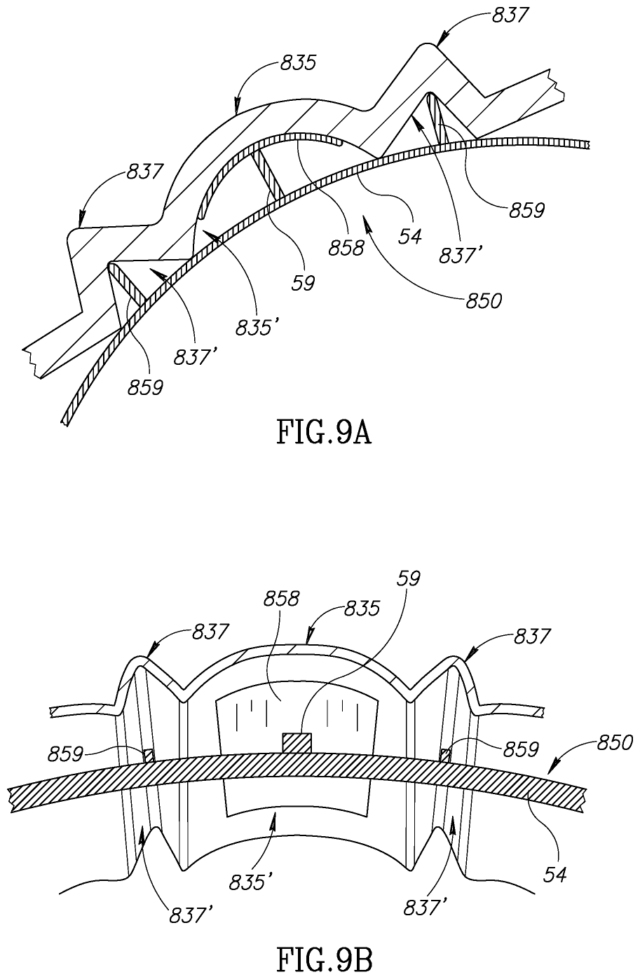

Reference is now made to FIG. 8 which illustrates a baking assist apparatus 800 for use with fluted pie pan 810, in accordance with a further embodiment. These components are generally similar to those shown and described above in conjunction with FIGS. 1A-4B, except as described herein. Accordingly, components and features shown in the embodiment of FIGS. 8-9B that are similar to such components and features shown and described above in conjunction with FIGS. 1A-4B, are depicted herein with the same reference numerals but having a prefix “8”, and are not otherwise described again herein in detail, except as may be required so as to understand the present embodiment.

Fluted pan 810 may have a solid, fully integrated base 812, or it may be formed as a ring with a circular insert which serves as a removable base, for added convenience after a pie has been fully baked and it is sought to remove the pie from the pan. This option is indicated by broken line 812′.

Fluted pan 810 has a conical peripheral wall 814 which has a generally wavelike configuration composed of an alternating pattern of convex recesses 815 interspersed with V-shaped notches 817. Baking assist apparatus 800 includes a fluted passive resistance band 830 and a fluted band support element 840, the exterior surfaces of which are configured to be similar to that of the wall 814, and so as to be parallel thereto when in position within the pan 810. As is readily seen in the drawing, band 830 has a series of alternating rounded protrusions 835 and V-shaped protrusions 837 which are proportioned and positioned so as to correspond to the recesses and notches of pan 810 when band 830 is placed therewithin, but spaced therefrom in accordance with the desired thickness of the pie crust. Correspondingly, band support element 840 has a series of alternating rounded protrusions 845 and V-shaped protrusions 847 which are proportioned and positioned so as to fit snugly into to the recesses and notches of band 830 when clement 840 is placed therewithin.

The operation and functioning of the presently illustrated and described baking assist apparatus 800 and fluted pie pan 810 are generally as shown and described above in conjunction with FIGS. 1A-4B, and are thus not described again herein. However, an advantage of the configuration of band 830 is in its ability to withstand the expansion and deformation pressures which the pie crust generally, and the pie wall in particular, undergoes during baking. As seen, in contrast to the conical configuration of band 30 10 (FIGS. 1A-4B), the current band 830 may be considered to be essentially segmented, namely, formed of a plurality of overlapping structural units, each formed of a single curved protrusion 835 formed contiguously with a pair of surrounding V-shaped protrusions 837. While each protrusion has its own, unique structural integrity, its inclusion as part of the above structural units in a force distribution arrangement therewith serves to enhance the structural integrity of the band 830, as a whole.

Furthermore, while band 30 is of uniform thickness, typically 3 mm, as stated above, present fluted band 830 has a thickness that is not necessarily uniform. Typically, the thickness Tc of the corners 837′ may be 20-40% greater than the standard thickness Ts of other portions of fluted band 830, as indicated in FIG. 17.

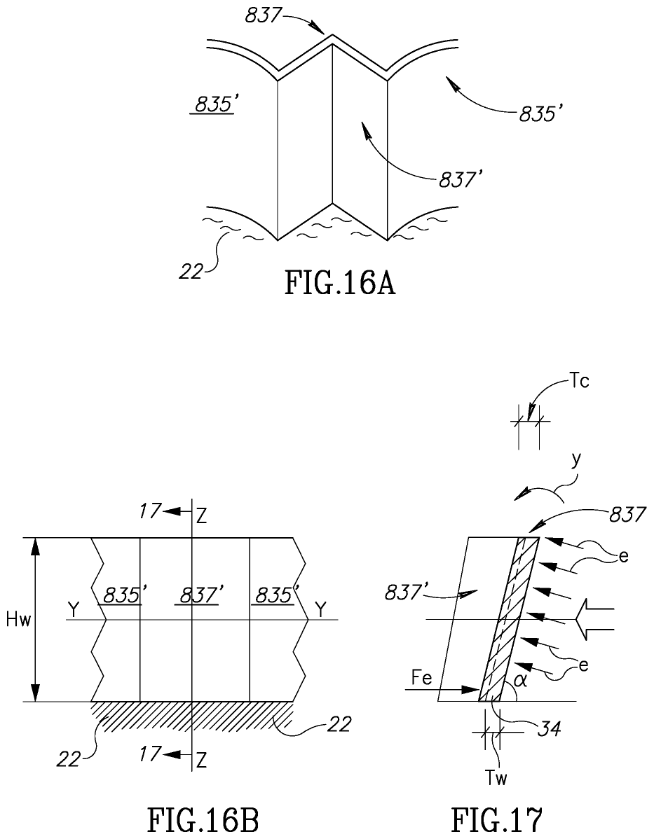

Reference is now made to FIGS. 16A and 16B, illustrating a portion of the web 831 of fluted resistance band 830 as shown and described above in conjunction with FIG. 8, as it would be positioned during baking. Fluted band 830 in its entirety may be either conical, as shown and described in conjunction with FIG. 8, or cylindrical (not shown), and has an axis of symmetry Z and an axis of bending Y.

As will be appreciated by persons skilled in the art, the ability of band 30 to be able to resist the expansion force Fe and thus to resist the expansion of the pie crust during baking is dependent on a number of components which include anchoring force (Fa) (FIG. 17), as shown and described above in conjunction with FIGS. 14-15B; and stiffness/resistance to flexure. While web 831 is highly flexible, it nonetheless has a certain inherent structural stiffness, namely a resistance to bending or flexure in the direction of bending axis Y, as described above. In the present embodiment, the division of band 830 into overlapping structural units of protrusions 835 and 837 enhances its overall structural integrity and stiffness.

Referring now to FIGS. 9A and 9B, baking assist apparatus 800 (FIG. 8) may also include an adjustable band expander 850. Expander 850 is generally similar to expander 50 as shown and described above in conjunction with FIGS. 6A-7, and is thus not described specifically again, herein, except with regard to features specific to the present embodiment. In the drawings, there is seen a single structural unit composed of a single curved protrusion 835 and a pair of juxtaposed V-shaped protrusions 837. Each curved protrusion has an inward-facing recessed curved surface 835′ associated therewith. Each V-shaped protrusion has an inward-facing notch 837′ associated therewith. As seen, in order to properly engage curved surface 835′, transmission element 56 (FIG. 7) is provided as a generally curved force transmission head 858, mounted onto ring 54 by connector 59. In order to engage notch 837′ however, transmission element 56 may have a single protrusion or fin 859 mounted directly onto ring 54.

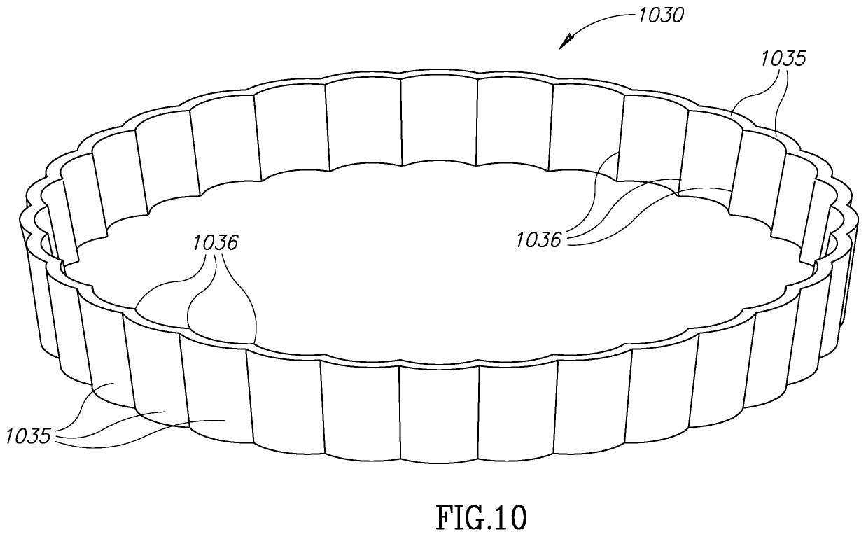

It will be appreciated by persons skilled in the art, that the above-described baking assist apparatus, generally, and the passive resistance band thereof, in particular, may be provided so as to have different aesthetic configurations. Accordingly, by way of non-limiting example, and with reference to FIGS. 10-13, differently configured passive resistance bands are illustrated, as described below, it being inherent that they are adapted for use with baking pans of similar configuration, and in association with which may be provided band support elements and band expanders, as part of the baking assist apparatus, also suitably configured for use therewith.

Referring now to FIG. 10, there is seen a circular or elliptical fluted passive resistance band 1030 formed of a uniform arrangement of juxtaposed rounded protrusions 1035, connected along vertical portions terminating in inward-facing ribs 1036.

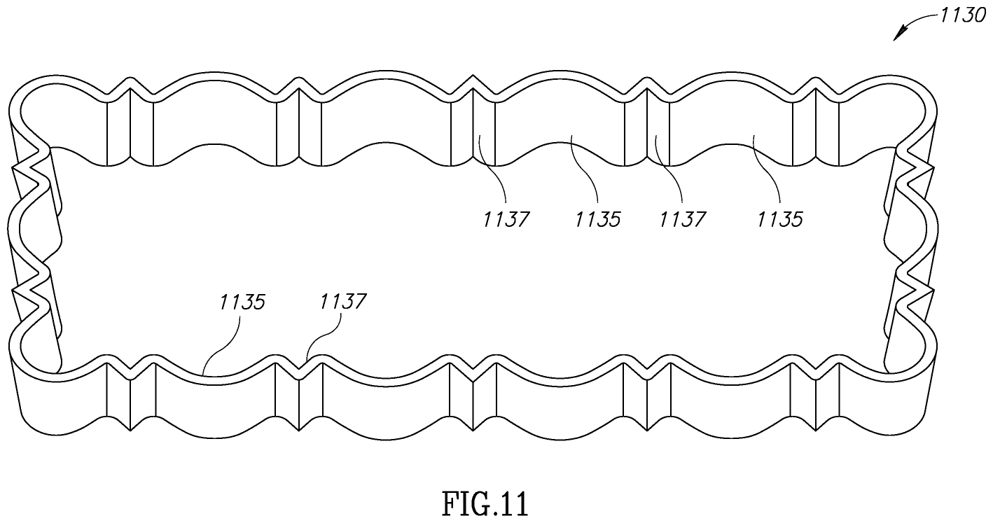

Referring now to FIGS. 11 and 12, there are seen two similar versions of a fluted passive resistance band 1130 formed as an oblong. Band 1130 is similar to band 830, shown and described above in conjunction with FIG. 8, in as much as it has a series of alternating rounded protrusions 1135 and V-shaped protrusions 1137 which are proportioned and positioned so as to correspond to the recesses and notches of a correspondingly shaped pan (not shown) when placed therewithin, but spaced therefrom in accordance with the desired thickness of the pie crust. Correspondingly, a band support element (not shown) for use with band 1130 has a series of alternating rounded protrusions and V-shaped protrusions which are proportioned and positioned so as to fit snugly into to the recesses and notches of band 1130 when placed therewithin.

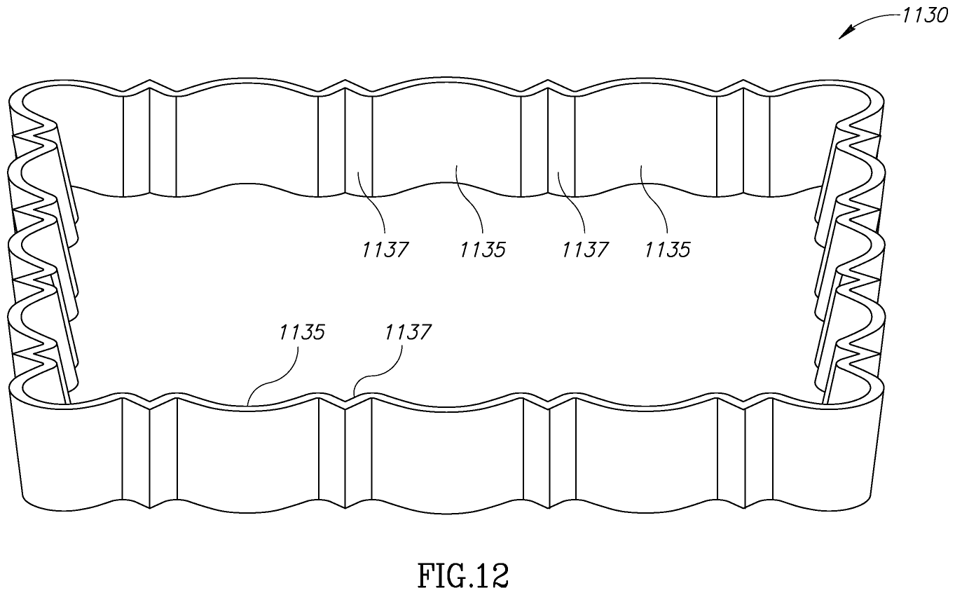

Referring now briefly to FIG. 13, there is seen a fluted passive resistance band 1330 composed of an alternating pattern of convex recesses 1335 interspersed with V-shaped notches 1337. It is generally similar to the embodiments of FIGS. 11 and 12 except that it is formed as a heart shape, and is thus not described further herein.

It will be appreciated by persons skilled in the art that the scope of the present invention is not limited by what has been shown and described hereinabove, merely by way of example. rather, the scope is limited solely by the claims, which follow:

1. Baking assist apparatus for use in the baking of an unbaked pie crust having a malleable dough base and a malleable peripheral dough wall extending transversely therefrom formed in and overlying a pie pan having a rigid base and a rigid peripheral wall extending transversely therefrom, said baking assist apparatus comprising:
a passive resistance band formed of a continuous, thin-walled, flexible, elongate web element formed of a heat resistant material having mutually parallel inward-facing and outward-facing surfaces separated by a predetermined web thickness, said surfaces terminating at first and second mutually parallel edges defining a web height therebetween,
wherein the dough wall has an outward-facing surface and an inward-facing surface, and said outward-facing surface of said web element is configured for positioning against the inward-facing surface of the dough wall of the pie crust,
wherein said web element is configured to impart to the dough wall a manually applied compressive force causing compression thereof against the rigid peripheral wall of the pie pan such that the dough wall adopts the shape of the rigid peripheral wall and so as to adopt a selected thickness,
and wherein at least one of said edges of said web element is configured for impressing into a surface of the unbaked pie crust juxtaposed to the dough wall so as to assist in anchoring said web element in said compression position, thereby to fixate the pie crust dough wall portion and to resist deformation thereof during baking.

2. Baking assist apparatus according to claim 1, wherein when the rigid peripheral wall of the pie pan has a predetermined closed, geometric shape, and wherein band is constructed so as to be deployable within and parallel to said rigid peripheral so as to be spaced therefrom by a predetermined uniform spacing S at all locations therealong.

3. Baking assist apparatus according to claim 2, wherein said band has a first, total length along its periphery and the rigid side wall of the pan has an interior face having a second, total length therealong, wherein said first total length is less than the second total length such that when said band is fully deployed within the pan, said band defines said spacing S from the rigid sidewall, said spacing equals a predetermined pie crust wall thickness.

4. Baking assist apparatus according to claim 1, wherein the rigid wall of the pan terminates in a peripheral rim at a predetermined height above the base of the pan, and said web has a height of magnitude that is at least the difference between said predetermined height of said peripheral rim and the minimum desired thickness of the malleable dough base.

5. Baking assist apparatus according to claim 1, wherein said band has an inward-facing surface, and said baking assist apparatus also includes a band support element which comprises a disc whose periphery is configured to fit within said band when fully deployed, and to assist said band in resisting inward deformation forces during baking.

6. Baking assist apparatus according to claim 5, wherein said band support element has a downward-facing surface and is configured to fit within said band so as to overlie the dough base, thereby to resist its tendency to puff up during baking.

7. Baking assist apparatus according to claim 6, wherein said band support element is formed with a plurality of vents extending through the thickness thereof, configured to release gas pressures accumulating within the dough base during baking.

8. Baking assist apparatus according to claim 5, wherein said band and said support element formed of an elastically deformable polymer.

9. Baking assist apparatus according to claim 8, wherein said band and said support element are formed of food grade silicone.

10. Baking assist apparatus according to claim 1, wherein said band is formed of an elastically deformable polymer, and wherein said baking assist apparatus also includes a band expander for insertion within said band when deployed, and for applying an outward pressure therealong.

11. Baking assist apparatus according to claim 10, wherein said band expander comprises:
an adjustable rigid ring for placement within and parallel to said band; and
a plurality of force transmission elements disposed along the periphery of said adjustable ring, each said force transmission element being radially mounted onto said periphery of said ring and having a force transmission head configured to engage said inward-facing surface of said web element so as to apply an outward force thereto.

12. Baking assist apparatus according to claim 1, wherein said first and second edges of said web element are of equal length.

13. Baking assist apparatus according to claim 1, wherein the rigid peripheral wall of the of pan slopes outwards, said edge of said web element configured for impressing into a surface of the unbaked pie crust is said first edge, and wherein the length of said first edge of said band is shorter than the length of said second edge of said band.

14. Baking assist apparatus according to claim 1, wherein the pie pan is a fluted pie pan whose rigid peripheral wall has a predetermined wavelike configuration, and wherein said outward-facing surface of said band is configured to have a similar configuration thereto, so as to be parallel thereto when positioned within the pan.

15. Baking assist apparatus according to claim 5, wherein the pie pan is a fluted pie pan whose rigid peripheral wall has a predetermined wavelike configuration, and wherein said outward-facing surface of said band and said periphery of said band support element are configured to have a similar configuration to that of the rigid peripheral wall, so as to be parallel thereto when positioned within the pan.
